(19) United States
(12) Patent Application Publication
(10) Pub. No.: US 2023/0063818 A1
(43) Pub. Date: Mar. 2, 2023

(54) DISPLAY TOUCH PANEL USING INFRARED TRANSPARENT FILMS

(71) Applicant: 3M INNOVATIVE PROPERTIES COMPANY, St. Paul, MN (US)

(72) Inventors: Bharat R. Acharya, Woodbury, MN (US); Edward Scott Hagermoser, Lancaster, MA (US); Fan Long, Guangzhou (CN)

(21) Appl. No.: 17/889,755

(22) Filed: Aug. 17, 2022

Related U.S. Application Data
(60) Provisional application No. 63/237,447, filed on Aug. 26, 2021.

(51) Int. Cl. G06F 3/042

(52) U.S. Cl. CPC G06F 3/0421

(57) ABSTRACT

A display system includes visible light-emitting first devices and infrared light-emitting second devices, infrared light-detecting third devices, an optically reflecting first film between the third devices and the first and second devices, and an optically reflecting second film between the first film and third devices. The optically reflecting second film defines first openings aligned with the third devices in a one-to-one correspondence. The first devices emit a first wavelength in a visible wavelength range, and the second devices are configured to emit a second wavelength in an infrared wavelength range. The third devices are configured to detect the second wavelength. The first film has an average reflectance of greater than 60% for the visible wavelength range, and an average transmittance of greater than 50% for the infrared wavelength range. The second film has an average reflectance of greater than 60% for the visible and infrared wavelength ranges.

### SUMMARY

In some aspects of the present description, a display system is provided, the display system including pluralities of substantially coplanar visible light-emitting first devices and infrared light-emitting second devices, a plurality of coplanar infrared light-detecting third devices, an optically reflecting first film disposed between the third devices and the pluralities of the first and second devices, and an optically reflecting second film disposed between the first film and the third devices. The optically reflecting second film defines a plurality of first openings therein. The first openings and the third devices are aligned with each other in a one-to-one correspondence. For a visible wavelength range extending from about 420 nm to about 680 nm and for an infrared wavelength range extending from about 850 nm to about 1050 nm: each of the first devices is configured to emit a first light having at least a first wavelength in the visible wavelength range, and each of the second devices is configured to emit a second light having at least a second wavelength in the infrared wavelength range. Each of the third devices is configured to detect a third light having the at least the second wavelength. For a substantially normally incident light, and for each of mutually orthogonal first and second polarization states: the first film has an average optical reflectance of greater than about 60% for the visible wavelength range and an average optical transmittance of greater than about 50% for the infrared wavelength range. For regions between the first openings, the second film has an average optical reflectance of greater than about 60% for each of the visible and infrared wavelength ranges.

In some aspects of the present description, a display system is provided, the display system including pluralities of substantially coplanar visible light-emitting first devices and infrared light-emitting second devices, a plurality of coplanar infrared light-detecting third devices, and an optically reflecting first film disposed between the third devices and the pluralities of the first and second devices. For a visible wavelength range extending from about 420 nm to about 680 nm and an infrared wavelength range extending from about 850 nm to about 1050 nm: each of the first devices is configured to emit a first light having at least a first wavelength in the visible wavelength range (with the primary purpose of providing backlight for the display), and each of the second devices is configured to emit a second light having at least a second wavelength in the infrared wavelength range (with the primary purpose of illuminating an object placed proximate the display for location and identification). Each of the third devices is configured to detect a third light having the at least the second wavelength. For a substantially normally incident light and for each of mutually orthogonal first and second polarization states, the first film has an average optical reflectance of greater than about 60% for the visible wavelength range and an average optical transmittance of greater than about 50% for the infrared wavelength range. An object disposed proximate the display system reflects at least portions of the first and second lights toward the third devices as first and second reflected lights. The first film is configured to reflect at least 60% of the first reflected light, and each of at least three of the third devices are configured to receive and detect at least 5% of the second reflected light transmitted through the first film. The detection by the at least three of the third devices, in combination, allows a detection of a location of the object.

In some aspects of the present description, a display system is provided, the display system includes pluralities of substantially coplanar visible light-emitting first devices (10) and infrared light-emitting second devices, a plurality of coplanar infrared light-detecting third devices, an optically reflecting first film disposed between the third devices and the pluralities of the first and second devices, an optically absorbing second film disposed proximate the first film opposite the first and second devices. The optically absorbing second film defines a plurality of first openings therein aligned with the third devices in a one-to-one correspondence. For a visible wavelength range extending from about 420 nm to about 680 nm and an infrared wavelength range extending from about 850 nm to about 1050 nm: each of the first devices is configured to emit a first light having at least a first wavelength in the visible wavelength range, and each of the second devices is configured to emit a second light having at least a second wavelength in the infrared wavelength range. Each of the third devices is configured to detect a third light having the at least the second wavelength. For a substantially normally incident light and for each of mutually orthogonal first and second polarization states: the first film has an average optical reflectance of greater than about 60% for the visible wavelength range, and an average optical transmittance of greater than about 50% for the infrared wavelength range. For regions between the first openings, the second film has an average optical absorption of greater than about 80% for at least the infrared wavelength range.

In some aspects of the present description, a display system is provided, the display system including a plurality of substantially coplanar visible light-emitting first devices, a plurality of substantially coplanar infrared light-emitting second devices, an optically reflecting first film disposed between the first and second devices, a plurality of coplanar infrared light-detecting third devices disposed on the second devices opposite the first film, and an optically absorbing second film disposed between the second and third devices. The optically absorbing second film defines a plurality of first openings therein aligned with the third devices in a one-to-one correspondence. For a visible wavelength range extending from about 420 nm to about 680 nm and an infrared wavelength range extending from about 850 nm to about 1050 nm: each of the first devices is configured to emit a first light having at least a first wavelength in the visible wavelength range, and each of the second devices is configured to emit a second light having at least a second wavelength in the infrared wavelength range. Each of the third devices is configured to detect a third light having the at least the second wavelength. For a substantially normally incident light and for each of mutually orthogonal first and second polarization states, the first film has an average optical reflectance of greater than about 60% for the visible wavelength range and an average optical transmittance of greater than about 50% for the infrared wavelength range.

### BRIEF DESCRIPTION OF THE DRAWINGS

FIG. 1 is a side view of a display system using infrared transparent films, in accordance with an embodiment of the present description;

FIGS. 2A and 2B provide data on the transmission versus wavelength performance of an optically reflective second film allowing transmission of near infrared wavelengths, in accordance with an embodiment of the present description;

FIGS. 3A and 3B provide data on the transmission versus wavelength performance of an optically reflective first film which substantially reflects visible and near infrared wavelengths, in accordance with an embodiment of the present description;

FIG. 4 provides a side view of the layered construction of a multilayer optical film, in accordance with an embodiment of the present description;

FIG. 5 is a side view of a display system using infrared transparent films, in accordance with an alternate embodiment of the present description;

FIG. 6 is a side view of a display system using a single infrared transparent film, in accordance with an alternate embodiment of the present description;

FIG. 7 is a side view of a display system using an infrared transparent film and an optically absorbing film, in accordance with an alternate embodiment of the present description;

FIG. 8 is a side view of a display system using an infrared transparent film and an optically absorbing layer disposed between light-detecting devices, in accordance with an alternate embodiment of the present description;

FIG. 9 is a side view of a display system using an infrared transparent film and an optical louver, in accordance with an alternate embodiment of the present description; and

FIG. 10 is a side view of a display system using infrared transparent films and an optical louver, in accordance with an alternate embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

Display and touch systems which utilize near infrared light (NIR) to detect the presence and status of objects (e.g., reading a fingerprint of a user) are becoming increasingly popular and available. However, the manufacture of these systems can be complex and the additional NIR components can add significant cost to the system. In addition to light sources (e.g., light emitting diodes) used for displaying the image, these touch systems need near infrared light sources and near infrared sensors to be able to read objects on or near the display. These added components must be placed such that they do not interfere with the displayed image (i.e., do not interfere with the light from the light sources in the backlight), which often means adding layers and manufacturing complexity to the optical stacks.

According to some aspects of the present description, a display system which uses optically reflecting films, and specifically films which will substantially reflect human-visible (visible) light and substantially transmit infrared light, to enable simple optical stacks with the desired functions without adding significant thickness. In some embodiments, a display system may include pluralities of substantially coplanar visible light-emitting first devices and infrared light-emitting second devices, a plurality of coplanar infrared light-detecting third devices (e.g., optical sensors), an optically reflecting first film disposed between the third devices and the pluralities of the first and second devices, and an optically reflecting second film disposed between the first film and the third devices.

In some embodiments, the optically reflecting second film may define a plurality of first openings therein. In some embodiments, the first openings and the third devices may be aligned with each other in a one-to-one correspondence (e.g., each of the third devices may be centered on, or otherwise aligned with, one of the first openings). In some embodiments, the first openings may be physical openings (through-holes in the film). In other embodiments, the first openings may be optical openings (i.e., may be optically transparent in the appropriate wavelengths without defining a physical opening.)

In some embodiments, the pluralities of the first devices and second devices may be disposed on a same common first substrate. In such embodiments, at least in regions between the first and second devices and for a substantially normally incident light and for each of the first and second polarization states, the first substrate may have an optical transmittance of greater than about 60%, or greater than about 70%, or greater than about 80%, or greater than about 90% at each of the at least the first and the second wavelengths. That is, the first substrate may be substantially optically transparent to the appropriate visible and infrared wavelengths.

In some embodiments, each of the third devices may be disposed on a same common second substrate. In some embodiments, at least in the regions between the third devices and for a substantially normally incident light and for each of the first and second polarization states, the second substrate may have an optical reflectance of greater than about 60%, or greater than about 70%, or greater than about 80%, or greater than about 90% at the at least the first wavelength. That is, the second substrate may be substantially optically reflective to at least the appropriate visible wavelengths. In some embodiments, for a substantially normally incident light and for each of the first and second polarization states, the second substrate may have an optical absorption of greater than about 60%, or greater than about 70%, or greater than about 80%, or greater than about 90% at the at least the second wavelength.

In some embodiments, for a visible wavelength range extending from about 420 nm to about 680 nm and for an infrared wavelength range extending from about 850 nm to about 1050 nm: each of the first devices may be configured to emit a first light having at least a first wavelength in the visible wavelength range (e.g., a visible light-emitting LED), and each of the second devices may be configured to emit a second light having at least a second wavelength in the infrared wavelength range (e.g., an infrared light-emitting LED). Each of the third devices is configured to detect a third light having the at least the second wavelength (e.g., an infrared light sensor. In some embodiments, for a substantially normally incident light, and for each of a mutually orthogonal first polarization state (e.g., light polarized to the x-axis of the film) and a second polarization state (e.g., light polarized to the y-axis of the film): the first film may have an average optical reflectance of greater than about 60%, or greater than about 70%, or greater than about 80%, or greater than about 90%, or greater than about 95%, or greater than about 98% for the visible wavelength range and an average optical transmittance of greater than about 50%, or greater than about 55%, or greater than about 60%, or greater than about 65%, or greater than about 70%, or greater than about 75%, or greater than about 80% for the infrared wavelength range.

For regions between the first openings, the second film has an average optical reflectance of greater than about 60%, or greater than about 70%, or greater than about 80%, or greater than about 90%, or greater than about 95%, or greater than about 98% for each of the visible and infrared wavelength ranges.

In some embodiments, the display system may be configured so that an object (e.g, such as the finger of a user, or the tip of a stylus) disposed proximate the display system reflects at least portions of the first and second lights toward the first and second films as first and second reflected lights. In such embodiments, the first film may be configured to reflect at least 60%, or at least 70%, or at least 80%, or at least 90%, or at least 95%, or at least 98% of the first reflected light. In some embodiments, at least one of the third devices may be configured to receive and detect a first portion of the second reflected light transmitted through at least one of the first openings. In some embodiments, at least one of the regions between the first openings may be configured to receive and reflect a different second portion of the second reflected light.

It should be noted that the primary purpose of the first devices is to emit the human-visible first light to illuminate the display (i.e., provide a backlight for the display), and not to illuminate the object. A portion of the first light emitted by the first devices will be reflected from the display and any corresponding films, such as reflective polarizers, diffusers, collimating films, etc., that may be a part of that display. Another portion of the first light will be transmitted through the display (in illuminating the display) and may reach the object and be reflected. This light will be reflected from the object as the first reflected light (along with the portion of first light that was reflected from the display and films in the display), which is in turn reflected by the first film. That is, the first film may act substantially as a reflector for visible light, and that light will be “recycled” for use in illuminating the display on the subsequent pass.

In some embodiments, the pluralities of first and second devices may be disposed such that they have no specific spatial relationship with each other, or with the first openings. In other embodiments, the pluralities of first and second devices may form a plurality of pairs of the first and the second devices, such that the pairs of the first and second devices define a plurality of second openings therebetween, the second openings aligned with the first openings in a one-to-one correspondence.

According to some aspects of the present description, a display system may include pluralities of substantially coplanar visible light-emitting first devices and infrared light-emitting second devices, a plurality of coplanar infrared light-detecting third devices (e.g., sensors), and an optically reflecting first film disposed between the third devices and the pluralities of the first and second devices.

In some embodiments, for a visible wavelength range extending from about 420 nm to about 680 nm and an infrared wavelength range extending from about 850 nm to about 1050 nm: each of the first devices may be configured to emit a first light having at least a first wavelength in the visible wavelength range, and each of the second devices may be configured to emit a second light having at least a second wavelength in the infrared wavelength range.

In some embodiments, each of the third devices may be configured to detect a third light having the at least the second wavelength. In some embodiments, for a substantially normally incident light (i.e., light substantially normal to the surface of the first film) and for each of mutually orthogonal first and second polarization states, the first film may have an average optical reflectance of greater than about 60%, or greater than about 70%, or greater than about 80%, or greater than about 90%, or greater than about 95%, or greater than about 98% for the visible wavelength range and an average optical transmittance of greater than about 50%, or greater than about 55%, or greater than about 60%, or greater than about 65%, or greater than about 70%, or greater than about 75%, or greater than about 80% for the infrared wavelength range. In some embodiments, an object disposed proximate the display system reflects at least portions of the first and second lights toward the third devices as first and second reflected lights. In some embodiments, the first film may be configured to reflect at least about 60%, or at least about 70%, or at least about 80%, or at least about 90%, or at least about 95%, or at least about 98% of the first reflected light, and each of at least three of the third devices may be configured to receive and detect at least 5%, or at least about 6%, or at least about 7%, or at least about 7%, or at least about 9%, or at least about 10%, or at least about 15%, or at least about 20% of the second reflected light transmitted through the first film. In some embodiments, the detection by the at least three of the third devices, in combination, allows a detection of a location of the object (i.e., the values of light measured by at least three of the third devices can be used to locate the object using triangulation or a similar technique).

According to some aspects of the present description, a display system may include pluralities of substantially coplanar visible light-emitting first devices and infrared light-emitting second devices, a plurality of coplanar infrared light-detecting third devices, an optically reflecting first film disposed between the third devices and the pluralities of the first and second devices, and an optically absorbing second film disposed proximate the first film opposite the first and second devices. In some embodiments, the optically absorbing second film may define a plurality of first openings therein aligned with the third devices in a one-to-one correspondence. In some embodiments, the first openings may be physical openings (through-holes in the film). In other embodiments, the first openings may be optical openings (i.e., may be optically transparent in the appropriate wavelengths without defining a physical opening). In some embodiments, for the regions between the first openings, the second film may have an average optical absorption of greater than about 60%, or greater than about 65%, or greater than about 70%, or greater than about 75%, or greater than about 80%, or greater than about 85%, or greater than about 90%, or greater than about 95%, or greater than about 98% for the visible wavelength range.

In some embodiments, the second film may be disposed between the first film and the third devices so that the second film is spaced apart from the third devices along a thickness direction (e.g., a z-axis) of the display system. In some embodiments, the second film may be substantially coplanar with the third devices, and each of the third devices may be disposed in the first opening of the second film corresponding to the third device. In some embodiments, the second film may be a louver film. In such embodiments, each of the regions between two of the adjacent openings (e.g., each of the louvers) are spaced apart along a first direction (e.g., an x-axis of the film), has a height H in a thickness direction (e.g., a z-axis of the film) of the display system, and has a width W along the first direction, such that the ratio of H/W is greater than or equal to 1, or greater than or equal to 1.5, or greater than or equal to 2, or greater than or equal to 3, or greater than or equal to 4, or greater than or equal to 5, or greater than or equal to 10, or greater than or equal to 25, or greater than or equal to 50.

In some embodiments, for a visible wavelength range extending from about 420 nm to about 680 nm and an infrared wavelength range extending from about 850 nm to about 1050 nm: each of the first devices may be configured to emit a first light having at least a first wavelength in the visible wavelength range, and each of the second devices may be configured to emit a second light having at least a second wavelength in the infrared wavelength range. In some embodiments, each of the third devices is configured to detect a third light having the at least the second wavelength.

In some embodiments, for a substantially normally incident light and for each of mutually orthogonal first and second polarization states: the first film may have an average optical reflectance of greater than about 60%, or greater than about 70%, or greater than about 80%, or greater than about 90%, or greater than about 95%, or greater than about 98% for the visible wavelength range, and an average optical transmittance of greater than about 50%, or greater than about 55%, or greater than about 60%, or greater than about 65%, or greater than about 70%, or greater than about 75%, or greater than about 80% for the infrared wavelength range. In some embodiments, for regions between the first openings, the second film may have an average optical absorption of greater than about 80%, or greater than about 85%, or greater than about 90%, or greater than about 95%, or greater than about 98% for at least the infrared wavelength range.

In some embodiments, the display system may be configured such that an object (e.g., a finger of a user, a stylus, etc.) disposed proximate the display system reflects at least portions of the first and second lights toward the first and second films as first and second reflected lights. In some embodiments, the first film may be configured to reflect at least 60%, or at least 70%, or at least 80%, or at least 90%, or at least 95%, or at least 98% of the first reflected light. In some embodiments, at least one of the third devices may be configured to receive and detect a first portion of the second reflected light transmitted through at least one of the first openings. In some embodiments, at least one of the regions between the first openings may be configured to receive and absorb a different second portion of the second reflected light. 98%) for the visible wavelength range.

According to some aspects of the present description, a display system may include a plurality of substantially coplanar visible light-emitting first devices, a plurality of substantially coplanar infrared light-emitting second devices, an optically reflecting first film disposed between the first and second devices, a plurality of coplanar infrared light-detecting third devices disposed on the second devices opposite the first film, and an optically absorbing second film disposed between the second and third devices.

In some embodiments, the optically absorbing second film may define a plurality of first openings therein aligned with the third devices in a one-to-one correspondence. In some embodiments, the second devices may be disposed on a same common second substrate, and wherein at least in regions between the second devices and for a substantially normally incident light and for each of the first and second polarization states, the second substrate may have an optical transmittance of greater than about 60%, or greater than about 70%, or greater than about 80%, or greater than about 90% at least at the at least the second wavelength. In some embodiments, each of the regions between two of the adjacent first openings may be spaced apart along a first direction (e.g., an x-axis of the film), and may have a height H in a thickness direction (e.g., a z-axis of the film) of the display system and a width W along the first direction, such that the ratio H/W is greater than or equal to about 1, or greater than or equal to about 1.5, or greater than or equal to about 2, or greater than or equal to about 3, or greater than or equal to about 4, or greater than or equal to about 5, or greater than or equal to about 10, or greater than or equal to about 25, or greater than or equal to about 50.

In some embodiments, for a visible wavelength range extending from about 420 nm to about 680 nm and an infrared wavelength range extending from about 850 nm to about 1050 nm: each of the first devices may be configured to emit a first light having at least a first wavelength in the visible wavelength range, and each of the second devices may be configured to emit a second light having at least a second wavelength in the infrared wavelength range. In some embodiments, each of the third devices may be configured to detect a third light having the at least the second wavelength. In some embodiments, for a substantially normally incident light and for each of mutually orthogonal first and second polarization states, the first film may have an average optical reflectance of greater than about 60%, or greater than about 70%, or greater than about 80%, or greater than about 90%, or greater than about 95%, or greater than about 98% for the visible wavelength range and an average optical transmittance of greater than about 50%, or greater than about 55%, or greater than about 60%, or greater than about 65%, or greater than about 70%, or greater than about 75%, or greater than about 80% for the infrared wavelength range.

In some embodiments, the display system may be configured so that an object (e.g., the finger of a user, the tip of a stylus, etc.) disposed proximate the display system may reflect at least portions of the first and second lights toward the third devices as first and second reflected lights. In some embodiments, the first film may be configured to reflect at least about 60%, or at least about 70%, or at least about 80%, or at least about 90%, or at least about 95%, or at least about 98% of the first reflected light. In some embodiments, at least one of the third devices may be configured to receive and detect a first portion of the second reflected light transmitted through at least one of the first openings. In some embodiments, at least one of the regions between the first openings may be configured to receive and absorb a different second portion of the second reflected light.

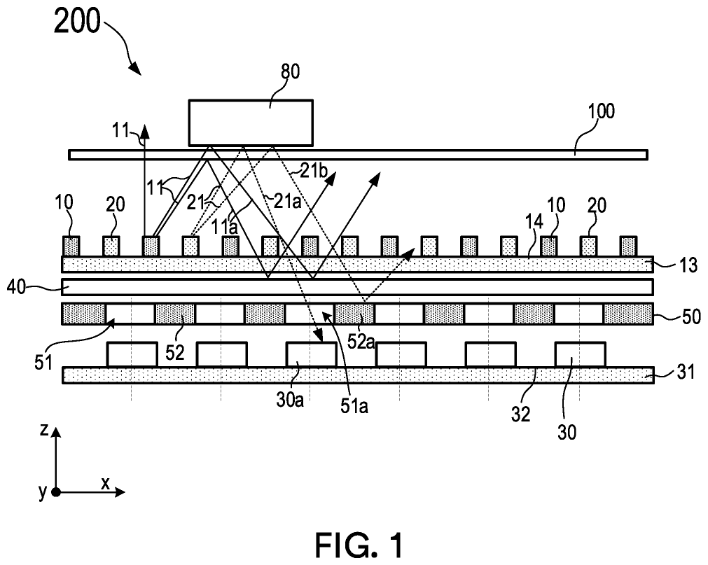

Turning now to the figures, FIG. 1 is a side view of a display system using infrared transparent films, according to the present description. In some embodiments, a display system 200 includes a plurality of visible light-emitting first devices 10 and a plurality of infrared light-emitting second devices 20. In some embodiments, first devices 10 and second devices 20 may be disposed on a common first substrate 13. In some embodiments, first devices 10 and second devices 20 may be disposed so as to define regions 14 between the first devices 10 and second devices 20.

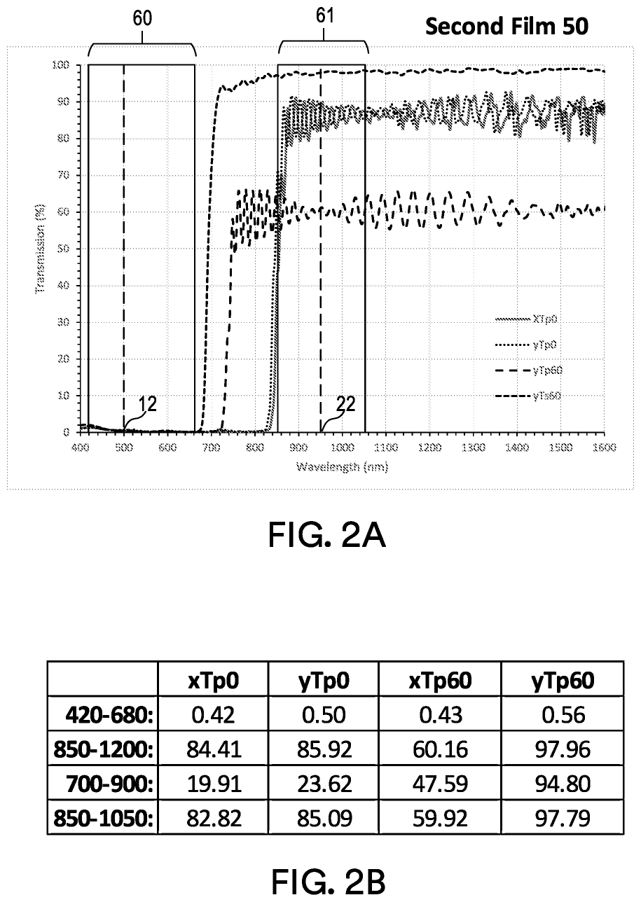

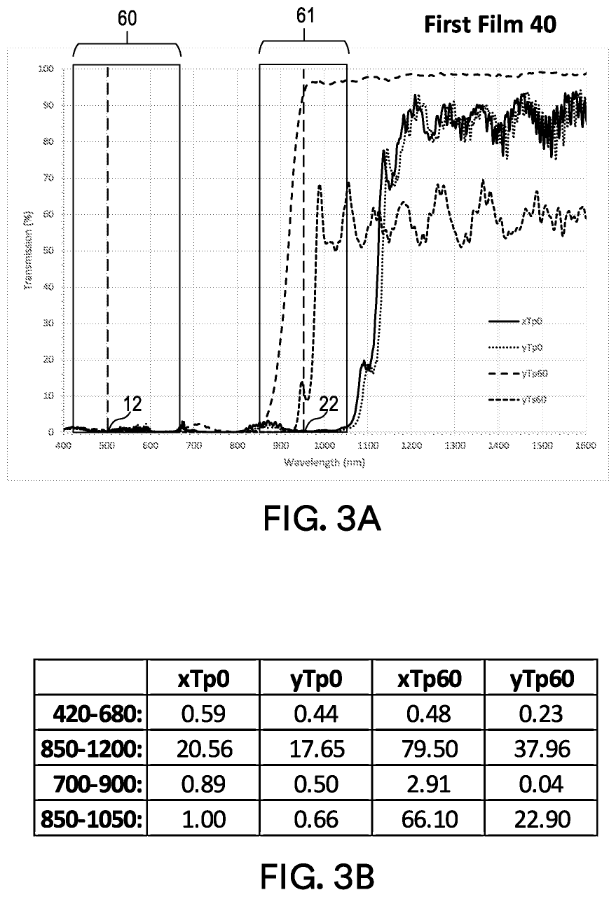

In some embodiments, first devices 10 may emit a first light 11, first light 11 including at least one wavelength (for example, 500 nm, see wavelength 12 in FIGS. 2A and 3A) in a visible wavelength range. In some embodiments, the visible wavelength range is a first wavelength range extending from about 420 nanometers (nm) to about 680 nm. In some embodiments, second devices 20 may emit a second light 21 including at least one wavelength (for example, 950 nm, see wavelength 22 in FIGS. 2A and 3A) in an infrared wavelength range. In some embodiments, the infrared wavelength range is a second wavelength range extending from about 850 nm to about 1050 nm.

As noted elsewhere herein, and as shown in FIG. 1, the primary purpose of first light 11 (i.e., the visible first light 11 emitted by first devices 10) is to illuminate the display 100. A portion of first light 11 will be transmitted by the display, thereby illuminating the display. Another portion of first light 11 may be reflected by the display and any corresponding films (e.g., a collimating film, reflective polarizer, diffuser, etc.) instead of being transmitted by the display 100.

A third portion of first light 11 may be transmitted by display 100 and then reflected by object 80 (e.g., the finger of a user) back into the display system 200. For the purposes of this document, and for all remaining figures, first reflected light 11 a is assumed to contain any of the portions of first light 11 that have been reflected back into the display system 200, including light reflected from the object 80 and light reflected by the display and any accompanying films. For simplicity, first reflected light 1 la may be shown only reflecting from object 80 in other figures herein, but the assumption above applies to all figures, that first reflected light 1 la contains any of the first light 11 that has been reflected back into the display system.

In some embodiments, display system 200 may further include a plurality of infrared light-detecting third devices (e.g., infrared light sensors) 30. In some embodiments, third devices 30 may be disposed on a common second substrate 31 so as to define regions 32 between adjacent third devices 30. In some embodiments, the regions 32 between third devices 30, for a substantially normally incident light and for each of the first and second polarization states, the second substrate 31 may have an optical reflectance of greater than about 60%, or greater than about 70%, or greater than about 80%, or greater than about 90% for wavelengths in the visible and infrared wavelength regions. In some embodiments, for a substantially normally incident light and for each of the first and second polarization states, the second substrate may have an optical absorption of greater than about 60%, or greater than about 70%, or greater than about 80%, or greater than about 90% at the at least for the infrared wavelength range.

In some embodiments, display system 200 may further include an optically reflective first film 40 and an optically reflective second film 50. In some embodiments, second film 50 may define a plurality of first openings 51 therein. In some embodiments, first openings 51 may be aligned with third devices 30 in a one-to-one correspondence (as shown by dashed lines extending between first openings 51 and third devices 30 in FIG. 1).

In some embodiments, display system 200 may further include a display 100 (e.g., a liquid crystal display, which may include other optical layers and/or films as required). In some embodiments, at least a portion of first light 11 emitted by one or more first devices 10 may pass through display 100 and be reflected from object 80 which is in proximity to display 100 (e.g., the finger of a user held near or in contact with display 100). First light 11 may be reflected from object 80 as first reflected light lla toward substrate 13. Please note that first reflected light 11a may include portions of first light 11 that are reflected from the display and any films associated with the display (e.g., reflective polarizers, diffusers, etc.) as well as those portions of first light 11 that are reflected from the object 80. In some embodiments, regions 14 of first substrate 13 may have an optical transmittance of greater than about 60%, or greater than about 70%, or greater than about 80%, or greater than about 90%, for substantially normally incident light in the visible and infrared wavelength ranges, such that first reflected light 11a is substantially transmitted by regions 14 of first substrate 13. Regions 14 of substrate 13 may substantially transmit first reflected light 11a regardless of the polarization type of first reflected light 11a (e.g., light polarized to either the x-axis or y-axis of the film).

In some embodiments, for a substantially normally incident light, and for each of a mutually orthogonal first polarization state (e.g., light polarized to the x-axis of the film) and a second polarization state (e.g., light polarized to the y-axis of the film): the first film 40 may have an average optical reflectance of greater than about 60%, or greater than about 70%, or greater than about 80%, or greater than about 90%, or greater than about 95%, or greater than about 98% for the visible wavelength range and an average optical transmittance of greater than about 50%, or greater than about 55%, or greater than about 60%, or greater than about 65%, or greater than about 70%, or greater than about 75%, or greater than about 80% for the infrared wavelength range.

In some embodiments, for regions 52 between the first openings 51, the second film 50 may have an average optical reflectance of greater than about 60%, or greater than about 70%, or greater than about 80%, or greater than about 90%, or greater than about 95%, or greater than about 98% for each of the visible and infrared wavelength ranges.

After being substantially transmitted by first substrate 13, first reflected light 11a is substantially reflected by first film 40 back toward display 100 (e.g., light 11a is substantially recycled and allowed to illuminate display 100).

In some embodiments, second light 21 (e.g., light in the infrared wavelength range) emitted by one or more second devices 20 may also pass through display 100 and be reflected from object 80 as second reflected light 21a and 21b toward substrate 13. Regions 14 of substrate 13 may substantially transmit second reflected light 21a and 21b regardless of its polarization type. Second reflected light 21a and 21b is similarly substantially transmitted by first film 40, allowing it to be directed toward second film 50. In some cases, second reflected light 21a passes through one of first openings 51 (e.g., opening 51a) and impinged on one of third devices 30 (e.g., third device 30a), as third device 30a is substantially aligned with first opening 51a. In other cases, second reflected light 21b has an angle of incidence such that it impinges on regions 52 (e.g., region 52a) and is substantially reflected. In some embodiments, the alignment of first openings 51 and third devices 30 allows the position of object 80 proximate display 100 to be easily determined, as only the third devices 30 that are closest to the location of object 80 receive the highest amount of reflected light 21a.

FIGS. 2A and 2B provide data on the transmission versus wavelength performance of one embodiment of the second film 50 of FIG. 1 allowing transmission of at least some wavelengths and polarizations of light including near infrared wavelengths. The four plotlines on the graph of FIG. 2A may be described as follows.

Plot xTp0 shows the optical transmission percentage for light polarized to the x-axis of second film 50 and incident on second film 50 at an angle of incidence of 0 degrees from the vertical (i.e., substantially normal to the surface of second film 50).

Plot yTp0 shows the optical transmission percentage for light polarized to the y-axis of second film 50 and incident on second film 50 at an angle of incidence of 0 degrees from the vertical (i.e., substantially normal to the surface of second film 50).

Plot xTp60 shows the optical transmission percentage for light polarized to the x-axis of second film 50 and incident on second film 50 at an angle of incidence of about 60 degrees from the vertical.

Plot yTp60 shows the optical transmission percentage for light polarized to the y-axis of second film 50 and incident on second film 50 at an angle of incidence of about 60 degrees from the vertical.

FIG. 2B is a table showing average transmission percentages for each of the four plot lines described above versus wavelength range. As discussed elsewhere herein, for substantially normally incident light (light with an incident angle of about 0 degrees) and for each of mutually orthogonal first and second polarization states (light polarized to either the x-axis or the y-axis), the embodiment of second film 50 shown in FIG. 2A has an average optical reflectance of 0.42% for xTp0 and 0.50% for yTp0 for light in the visible wavelength range 60 extending from about 420 nm to about 680 nm. On the other hand, for substantially normally incident light (light with an incident angle of about 0 degrees) and for each of mutually orthogonal first and second polarization states (light polarized to either the x-axis or the y-axis), the embodiment of second film 50 shown in FIG. 2A has an average optical reflectance of 82.82% for xTp0 and 85.09% for yTp0 for light in the infrared wavelength range 61 extending from about 850 nm to about 1050 nm.

In some embodiments, the visible wavelength range 60 may be emitted by first devices 10 (see FIG. 1) and may contain at least a first wavelength 12 (e.g., 500 nm). In some embodiments, the infrared wavelength range 61 may be emitted by second devices 20 (see FIG. 1) and may contain at least a second wavelength 22 (e.g., 950 nm). In some embodiments, third devices 30 (see FIG. 1) may be configured to detect at least second wavelength 22 in infrared wavelength range 61.

FIGS. 3A and 3B provide data on the transmission versus wavelength performance of one embodiment of the first film 40 of FIG. 1 which substantially reflects wavelengths and polarizations of light including both visible and near infrared wavelengths. The four plotlines on the graph of FIG. 3A may be described as follows.

Plot xTp0 shows the optical transmission percentage for light polarized to the x-axis of first film 40 and incident on first film 40 at an angle of incidence of 0 degrees from the vertical (i.e., substantially normal to the surface of first film 40).

Plot yTp0 shows the optical transmission percentage for light polarized to the y-axis of first film 40 and incident on first film 40 at an angle of incidence of 0 degrees from the vertical (i.e., substantially normal to the surface of first film 40).

Plot xTp60 shows the optical transmission percentage for light polarized to the x-axis of first film 40 and incident on first film 40 at an angle of incidence of about 60 degrees from the vertical.

Plot yTp60 shows the optical transmission percentage for light polarized to the y-axis of first film 40 and incident on first film 40 at an angle of incidence of about 60 degrees from the vertical.

FIG. 3B is a table showing average transmission percentages for each of the four plot lines described above versus wavelength range. As discussed elsewhere herein, for substantially normally incident light (light with an incident angle of about 0 degrees) and for each of mutually orthogonal first and second polarization states (light polarized to either the x-axis or the y-axis), the embodiment of first film 40 shown in FIG. 3A has an average optical reflectance of 0.59% for xTp0 and 0.44% for yTp0 for light in the visible wavelength range extending from about 420 nm to about 680 nm Similarly, for substantially normally incident light (light with an incident angle of about 0 degrees) and for each of mutually orthogonal first and second polarization states (light polarized to either the x-axis or the y-axis), the embodiment of first film 40 shown in FIG. 3A has an average optical reflectance of 1% for xTp0 and 0.66% for yTp0 for light in the infrared wavelength range extending from about 850 nm to about 1050 nm.

In some embodiments, the visible wavelength range 60 may be emitted by first devices 10 (see FIG. 1) and may contain at least a first wavelength 12 (e.g., 500 nm). In some embodiments, the infrared wavelength range 61 may be emitted by second devices 20 (see FIG. 1) and may contain at least a second wavelength 22 (e.g., 950 nm). In some embodiments, third devices 30 (see FIG. 1) may be configured to detect at least second wavelength 22 in infrared wavelength range 61.

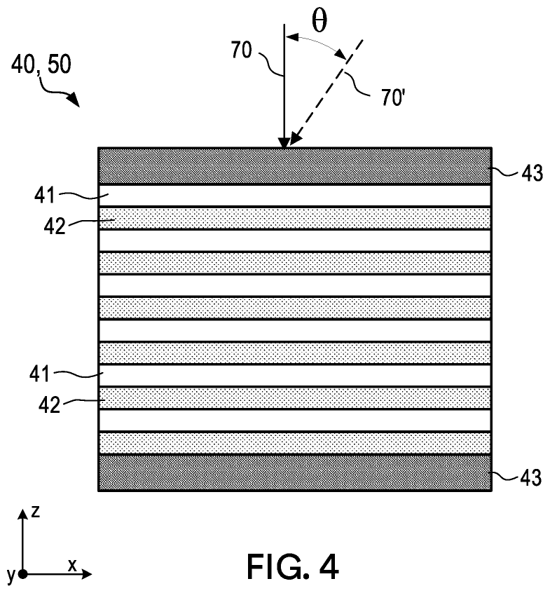

FIG. 4 provides a side view of the layered construction of a multilayer optical film, including first film 40 and second film 50 of the embodiment of FIG. 1. In some embodiments, at least one of the first film 40 and second film 50 include a plurality of alternating different polymeric first layers 41 and second layers 42 numbering at least 10, or at least 20, or at least 50, or at least 75, or at least 100, or at least 150, or at least 200, or at least 250, or at least 300, or at least 400 in total. In some embodiments, each of the polymeric first layers 41 and second layers 42 may have an average thickness of less than about 500 nm, or about 400 nm, or about 350 nm, or about 300 nm, or about 250 nm, or about 200 nm. In some embodiments, polymeric first layers 41 may have an index of refraction which differs from the index of refraction of polymeric second layers 42. By configuring the index of refraction, thickness, and orientation of alternating polymeric first layers 41 and polymeric second layers 42, it is possible to create optical films which have characteristics such as those shown in FIGS. 2A and 3A. As discussed elsewhere herein, these characteristics may be different for incident light 70, based on the value of the angle of incidence, θ. In FIG. 4, incident light 70 is shown at an angle of incidence which is substantially normal to the surface of the film 40/50 (i.e., θ=0 degrees), and incident light 70′ is shown at a non-zero angle of incidence θ (e.g., θ=60 degrees). For example, the plots for lines xTp60 and yTp60 (having a value for θ of 60 degrees) in

FIGS. 2A and 3A are different from the plots for lines xTp0 and yTp0 (having a value of θ of 0 degrees). In some embodiments, the at least one of the first film 40 and second film 50 may further include at least one skin layer 43, which may have an average thickness of greater than about 500 nm, or about 750 nm, or about 1000 nm, or about 1500 nm, or about 2000 nm.

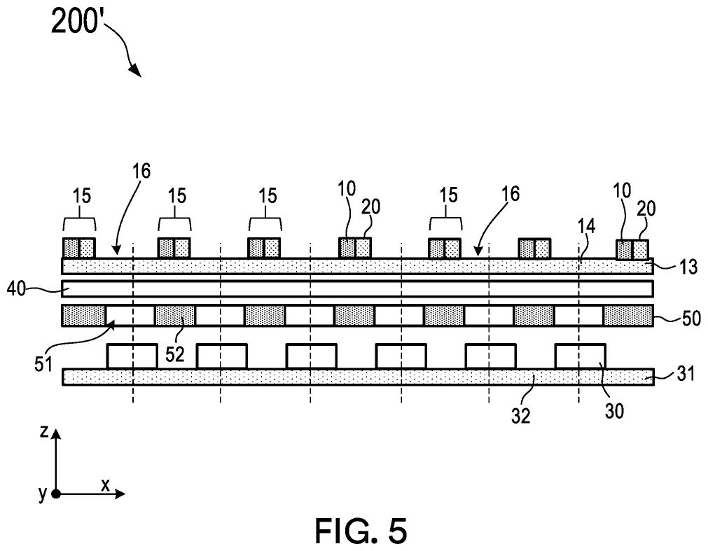

FIG. 5 shows an alternate embodiment of display system 200 of FIG. 1. Elements in embodiment 200′ of the display system shown in FIG. 5 are assumed to have a similar function as the like-numbered elements in FIG. 1 unless specifically stated otherwise, and therefore may not be described further in the discussion of FIG. 5. In the embodiment of FIG. 5, the plurality of first devices 10 and second devices 20 form a plurality of pairs 15 of first devices 10 and second devices 20. The pairs 15 define a plurality of second openings 16 therebetween. Second openings 16 are aligned with first openings 51 in a one-to-one correspondence. It should be noted that, although the first devices 10 and second devices 20 are shown with little or no space between them in each pair 15, other embodiments may have a space between first devices 10 and second devices 20. It should also be noted that the total number of first devices 10 may be different than the total number of second devices 20. That is, some of the pairs 15 shown in FIG. 5 may be replaced with a single first device 10 or a single second device 20, or any combination or number of first devices 10 and second devices 20.

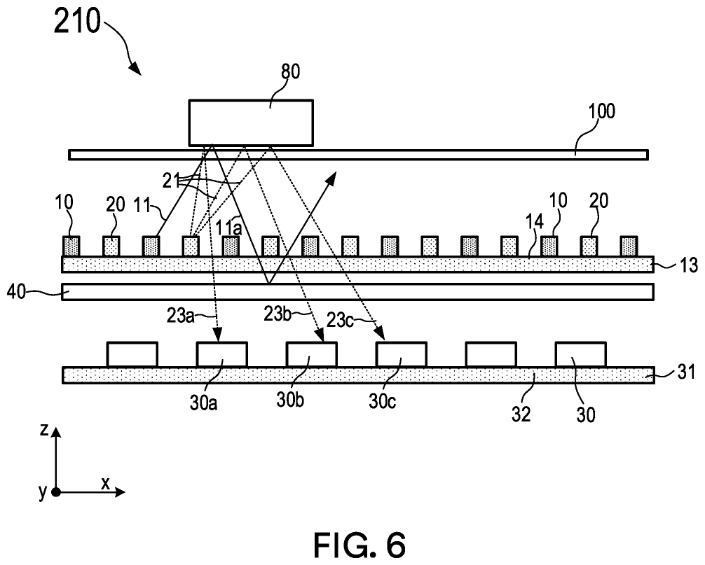

FIG. 6 is a side view of another alternate embodiment of a display system according to the present description. Elements in embodiment 210 of the display system shown in FIG. 6 are assumed to have a similar function as the like-numbered elements in FIG. 1 unless specifically stated otherwise, and therefore may not be described further in the discussion of FIG. 6. In display system 210 of FIG. 6, the optical stack uses only a single optically reflective film, optically reflective first film 40 (which has a similar function to first film 40 of FIG. 1), and optically reflective second film 50 of FIG. 1 has been removed in embodiment 210. In display system 210, second devices 20 emit a second light 21 which is reflected by an object 80 as second reflected light 23a, 23b, and 23c. As with embodiment 200 of FIG. 1, the second reflected light 23a, 23b, and 23c is substantially transmitted by first film 40 and impinges on third devices 30. As there is no second film (such as second film 50 of FIG. 1, with first openings 51), the second reflected light 23a, 23b, and 23c may be reflected onto a larger array of third devices 30. That is, as the second reflected light 23a, 23b, and 23c are no longer limited by the presence of a second film 50 with first openings 51, the second reflected light 23a, 23b, and 23c may reach additional third devices 30, such as third devices 30b and 30c (rather than being reflected by regions 52 of second film 50). However, as the amount of light reaching the array of third devices will vary with distance from the light source (e.g., the amount of second reflected light 23a reaching third device 30a will be larger than the amount of second reflected light 23b reaching third device 30b and even larger than the amount of second reflected light 23c reaching third device 30c), the difference in measured values seen at third devices 30a, 30b, and 30c may be used to determine the location of the object 80 relative to the display 100. That is, the relative strength of the measurements seen at third devices 30a, 30b, and 30c can be used to triangulate a position of object 80 relative to the display 100.

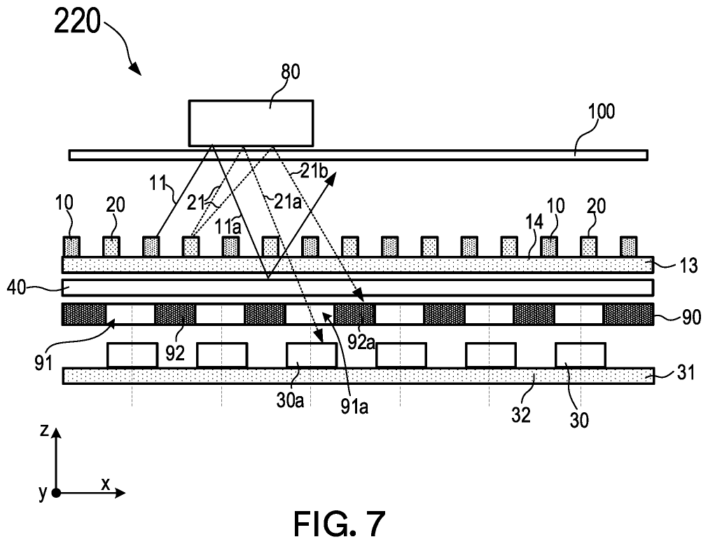

FIG. 7 is a side view of yet another alternate embodiment of a display system according to the present description. Elements in embodiment 220 of the display system shown in FIG. 7 are assumed to have a similar function as the like-numbered elements in FIG. 1 unless specifically stated otherwise, and therefore may not be described further in the discussion of FIG. 7. In some embodiments, display system 220 includes a plurality of visible light-emitting first devices 10 and a plurality of infrared light-emitting second devices 20, where first devices 10 and second devices 20 are substantially coplanar (e.g., disposed on a common first substrate 13). In some embodiments, display system 220 further includes a plurality of coplanar (e.g., disposed on a common second substrate 31) infrared light-detecting third devices 30. In some embodiments, an optically reflecting first film 40 is disposed between the third devices 30 and the pluralities of first 10 and second devices 20, and an optically absorbing second film 90 is disposed proximate the first film 40 opposite the pluralities of first 10 and second devices 20. In some embodiments, the second film 90 may define a plurality of first openings 91 therein, such that the first openings 91 are aligned with the third devices 30 in a one-to-one correspondence. In some embodiments, each first device 10 emits a first light 11 in a visible wavelength range, portions of which may be transmitted through display 100 and reflected from an object 80 as first reflected light 11 a. In some embodiments, first reflected light 11 a may pass through first substrate 13 and be reflected from first film 40 (i.e., first film 40 may substantially reflect light in the visible wavelength range, as discussed elsewhere herein, and may substantially transmit light in the infrared wavelength range).

In some embodiments, each second device 20 emits a second light 21 in an infrared wavelength range, which may be transmitted through display 100 and be reflected from an object 80 as second reflected light 21a and 21b. In some embodiments, second reflected light 21a, 21b may pass through first substrate 13. If second reflected light 21a impinges on second film 90 at a location corresponding to one of the first openings 91 (e.g., first opening 91a), the second reflected light 21a may be substantially transmitted therethrough and impinge on one of the third devices 30 (e.g., third device 30a). However, if second reflected light 21b impinges on second film 90 at a location corresponding to a region 92 between first openings 91, the second reflected light 21b may be substantially absorbed. In some embodiments, second film 90 (and, specifically, regions 92 of second film 90) may have an average optical absorption of greater than about 80%, or greater than about 85%, or greater than about 90%, or greater than about 95%, or greater than about 98% for at least the second wavelength (e.g., second wavelength 22, FIGS. 2A and 3A) in the infrared wavelength range. In some embodiments, for a substantially normally incident light and for each of the first and second polarization states (e.g., light polarized to the x-axis of the film and the y-axis of the film, respectively), the second substrate may have an optical absorption of greater than about 60%, or greater than about 70%, or greater than about 80%, or greater than about 90% at the at least the second wavelength (e.g., second wavelength 22, FIGS. 2A and 3A). In some embodiments, first openings 91 may be physical openings (through-holes in the film). In other embodiments, first opening 91 may be optical openings (i.e., may be optically transparent in the appropriate wavelengths without defining a physical opening.)

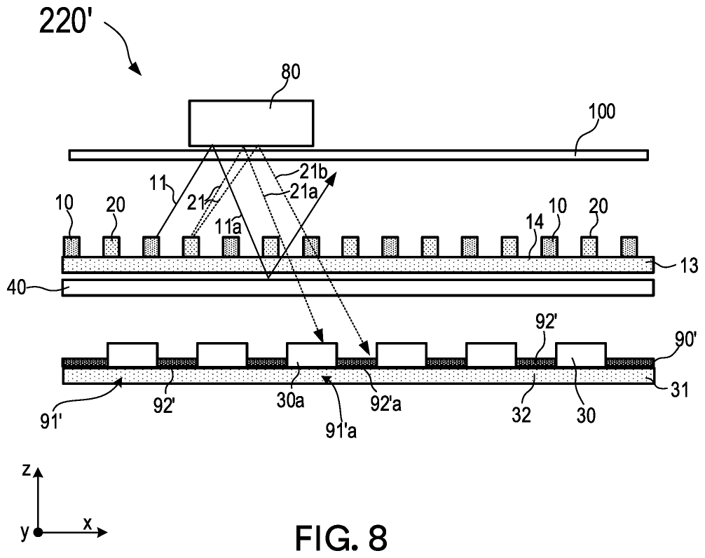

In some embodiments, the second film 90 is disposed between first film 40 and third devices 30, such that second film 90 is spaced apart from the third devices 30 along a thickness direction (e.g., the z-axis shown in FIG. 7) of the display system, as shown in FIG. 7. In other embodiments, the second film 90 may be substantially coplanar with third devices 30, such that each third device 30 is disposed in a corresponding first opening 91. An example of this is shown in FIG. 8, showing display system 220′.

Elements in embodiment 220′ of the display system shown in FIG. 8 are assumed to have a similar function as the like-numbered elements in FIG. 1 and FIG. 7 unless specifically stated otherwise, and therefore may not be described further in the discussion of FIG. 8. In the embodiment shown in FIG. 8, second film 90′ is directly adjacent to and in contact with second substrate 31, such that each of third devices 30 is disposed in a corresponding one of first openings 91′ and each of the third devices 30 is spaced apart from other third devices 30 by regions 92′. Similar to regions 92 described in FIG. 7, regions 92′ are substantially optically absorbing at least in the second wavelength (e.g., second wavelength 22, FIGS. 2A and 3A). In some embodiments, second film 90′ may be a coating layered in regions 92′, the coating having the required optical absorption properties as described herein.

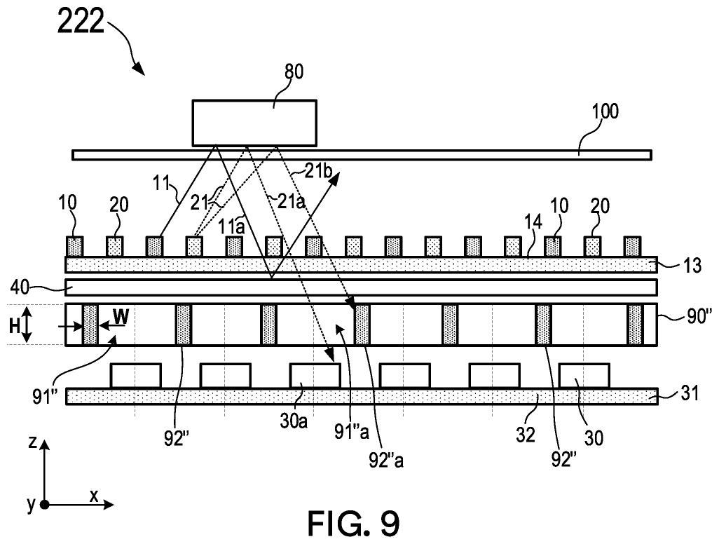

FIG. 9 is a side view of an embodiment of a display system 222 using an infrared transparent film in conjunction with an optical louver. Elements in embodiment 222 of the display system shown in FIG. 9 are assumed to have a similar function as the like-numbered elements in FIG. 1, and other figures herein, unless specifically stated otherwise, and therefore may not be described further in the discussion of FIG. 9.

In the embodiment of display system 222 of FIG. 9, the second film 90″ is a louver film. In some embodiments, louver film 90″ includes a plurality of regions 92″ (e.g., a plurality of spaced-apart slats) between first openings 91″. In some embodiments, each region 92″ may be spaced along a first direction (e.g., the x-axis shown in FIG. 9), have a height H in a thickness direction (e.g., the z-axis shown in FIG. 9) of the display system, and a width W along the first direction. In some embodiments, the ratio of H/W may be greater than or equal to 1, or greater than or equal to 1.5, or greater than or equal to 2, or greater than or equal to 3, or greater than or equal to 4, or greater than or equal to 5, or greater than or equal to 10, or greater than or equal to 25, or greater than or equal to 50. In some embodiments, for the regions 92″ between first openings 91″, the louver film 90″ may have an average optical absorption of greater than about 60%, or greater than about 65%, or greater than about 70%, or greater than about 75%, or greater than about 80%, or greater than about 85%, or greater than about 90%, or greater than about 95%, or greater than about 98% for the visible wavelength range.

In some embodiments, first openings 91″ may be physical openings (through-holes in the film). In other embodiments, first openings 91″ may be optical openings (i.e., may be optically transparent in the appropriate wavelengths without defining a physical opening). In some embodiments, first openings 91″ may be aligned with third devices 30 in a one-to-one correspondence.

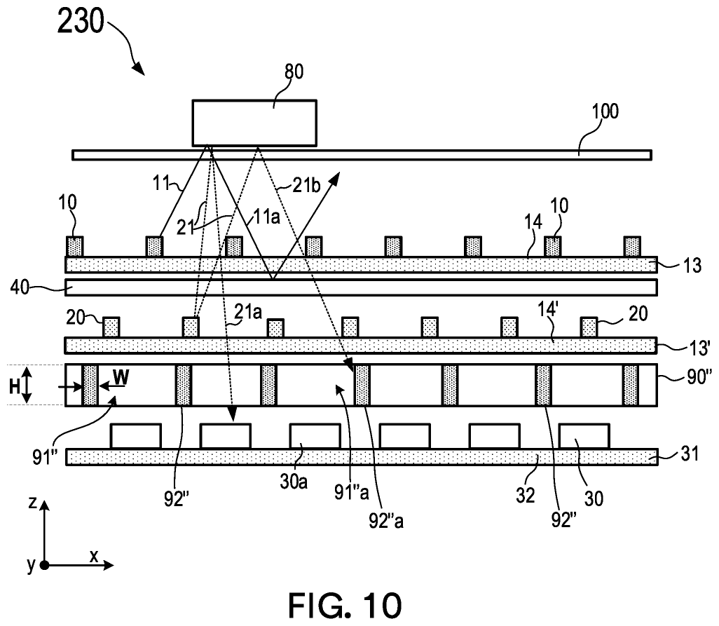

In the embodiments shown in FIGS. 1 and 5-9, the plurality of first devices 10 (i.e., the visible light-emitting devices) and the plurality of second devices 20 (i.e., the infrared light-emitting devices) have been shown as being coplanar with each other (i.e., disposed on a common substrate 13). However, in any of these previous embodiments, the plurality of second devices 20 may be separated from the plurality of first devices 10 using a separate substrate (i.e., a third substrate, beyond first substrate 13 and second substrate 31). One example of such an embodiment is shown in FIG. 10. Elements in embodiment 230 of the display system shown in FIG. 10 are assumed to have a similar function as the like-numbered elements in FIG. 1, FIG. 9, and other figures herein, unless specifically stated otherwise, and therefore may not be described further in the discussion of FIG. 10.

In display system 230, the plurality of second devices 20 have been separated from first substrate 13 (and from first devices 10, which remain on first substrate 13). Second devices 20 are instead disposed on third substrate 13′, which is itself disposed beneath first film 40 (i.e., on a side of first film 40 opposite first substrate 13) and above second film 90″ (i.e., on a side of second film 90″ opposite third devices 30). In some embodiments, regions 14′ of third substrate 13′ between the second devices 20. For a substantially normally incident light and for each of the first and second polarization states, the third substrate 14′ has an optical transmittance of greater than about 60%, or greater than about 70%, or greater than about 80%, or greater than about 90% at least at the at least the second wavelength (e.g., second wavelength 22 of FIGS. 2A and 3A). Each of the second devices 20 emits a second light 21 which may be substantially transmitted through first film 40 (as first film 40 will substantially reflect light in a visible wavelength range, and substantially transmit light in an infrared wavelength range, as discussed elsewhere herein.) Second light 21 is then reflected from object 80 and passes back through (is substantially transmitted by) first film 40 and is similarly substantially transmitted by third substrate 14′ to either be substantially transmitted by first openings 91″ or substantially absorbed by regions 92″ of second film 90″.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed:

1. A display system comprising:
pluralities of substantially coplanar visible light-emitting first devices and infrared light-emitting second devices;
a plurality of coplanar infrared light-detecting third devices;
an optically reflecting first film disposed between the third devices and the pluralities of the first and second devices; and
an optically reflecting second film disposed between the first film and the third devices and defining a plurality of first openings therein, the first openings and the third devices aligned with each other in a one-to-one correspondence;
such that for a visible wavelength range extending from about 420 nm to about 680 nm and an infrared wavelength range extending from about 850 nm to about 1050 nm:
each of the first devices is configured to emit a first light having at least a first wavelength in the visible wavelength range;
each of the second devices is configured to emit a second light having at least a second wavelength in the infrared wavelength range;
each of the third devices is configured to detect a third light having the at least the second wavelength; and
for a substantially normally incident light and for each of mutually orthogonal first and second polarization states:
the first film has an average optical reflectance of greater than about 60% for the visible wavelength range and an average optical transmittance of greater than about 50% for the infrared wavelength range; and
for regions between the first openings, the second film has an average optical reflectance of greater than about 60% and infrared wavelength ranges.

2. The display system of claim 1, wherein the pluralities of the first and second devices are disposed on a same common first substrate, and wherein at least in regions between the first and second devices and for a substantially normally incident light and for each of the first and second polarization states, the first substrate has an optical transmittance of greater than about 60% at each of the at least the first and the second wavelengths.

3. The display system of claim 1, wherein the third devices are disposed on a same common second substrate, and wherein at least in regions between the third devices and for a substantially normally incident light and for each of the first and second polarization states, the second substrate has an optical reflectance of greater than about 60% at the at least the first wavelength.

4. The display system of claim 3, wherein for a substantially normally incident light and for each of the first and second polarization states, the second substrate has an optical absorption of greater than about 60% at the at least the second wavelength.

5. The display system of claim 1 configured so that an object disposed proximate the display system reflects at least portions of the first and second lights toward the first and second films as first and second reflected lights, the first film configured to reflect at least 60% of the first reflected light, at least one of the third devices configured to receive and detect a first portion of the second reflected light transmitted through at least one of the first openings, at least one of the regions between the first openings configured to receive and reflect a different second portion of the second reflected light.

6. The display system of claim 1, wherein pluralities of first and second devices form a plurality of pairs of the first and the second devices, the pairs of the first and second devices defining a plurality of second openings therebetween aligned with the first openings in a one-to-one correspondence.

7. The display system of claim 1, wherein the first openings are physical openings.

8. A display system comprising:
pluralities of substantially coplanar visible light-emitting first devices and infrared light-emitting second devices;
a plurality of coplanar infrared light-detecting third devices;
an optically reflecting first film disposed between the third devices and the pluralities of the first and second devices; and
an optically absorbing second film disposed proximate the first film opposite the first and second devices and defining a plurality of first openings therein, the first openings and the third devices aligned with each other in a one-to-one correspondence;
such that for a visible wavelength range extending from about 420 nm to about 680 nm and an infrared wavelength range extending from about 850 nm to about 1050 nm:
each of the first devices is configured to emit a first light having at least a first wavelength in the visible wavelength range;
each of the second devices is configured to emit a second light having at least a second wavelength in the infrared wavelength range;
each of the third devices is configured to detect a third light having the at least the second wavelength; and
for a substantially normally incident light and for each of mutually orthogonal first and second polarization states:
the first film has an average optical reflectance of greater than about 60% for the visible wavelength range and an average optical transmittance of greater than about 50% for the infrared wavelength range; and
for regions between the first openings, the second film has an average optical absorption of greater than about 80% for at least the infrared wavelength range.

9. The display system of claim 8 configured so that an object disposed proximate the display system reflects at least portions of the first and second lights toward the first and second films as first and second reflected lights, the first film configured to reflect at least 60% of the first reflected light, at least one of the third devices configured to receive and detect a first portion of the second reflected light transmitted through at least one of the first openings, at least one of the regions between the first openings configured to receive and absorb a different second portion of the second reflected light.

10. The display system of claim 8, wherein the second film is disposed between the first film and the third devices so that the second film is spaced apart from the third devices along a thickness direction of the display system.

11. The display system of claim 8, wherein the second film is substantially coplanar with the third devices, and wherein each of the third devices is disposed in the first opening of the second film corresponding to the third device.

12. The display system of claim 8, wherein the second film is a louver film, and wherein each of the regions between two of the adjacent openings spaced apart along a first direction, has a height H in a thickness direction of the display system and a width W along the first direction, H/W≥1.

13. The display system of claim 8, wherein the first openings are optical, not physical, openings.

14. The display system of claim 8, wherein for the regions between the first openings, the second film has an average optical absorption of greater than about 60% for the visible wavelength range.

15. A display system comprising:
a plurality of substantially coplanar visible light-emitting first devices;
a plurality of substantially coplanar infrared light-emitting second devices;
an optically reflecting first film disposed between the first and second devices;
a plurality of coplanar infrared light-detecting third devices disposed on the second devices opposite the first film; and
an optically absorbing second film disposed between the second and third devices and defining a plurality of first openings therein, the first openings and the third devices aligned with each other in a one-to-one correspondence;
such that for a visible wavelength range extending from about 420 nm to about 680 nm and an infrared wavelength range extending from about 850 nm to about 1050 nm:
each of the first devices is configured to emit a first light having at least a first wavelength in the visible wavelength range;
each of the second devices is configured to emit a second light having at least a second wavelength in the infrared wavelength range;
each of the third devices is configured to detect a third light having the at least the second wavelength; and
for a substantially normally incident light and for each of mutually orthogonal first and second polarization states, the first film has an average optical reflectance of greater than about 60% for the visible wavelength range and an average optical transmittance of greater than about 50% for the infrared wavelength range.

16. The display system of claim 15 configured so that an object disposed proximate the display system reflects at least portions of the first and second lights toward the third devices as first and second reflected lights, the first film configured to reflect at least 60% of the first reflected light, at least one of the third devices configured to receive and detect a first portion of the second reflected light transmitted through at least one of the first openings, at least one of the regions between the first openings configured to receive and absorb a different second portion of the second reflected light.

17. The display system of claim 15, wherein each of the regions between two of the adjacent openings spaced apart along a first direction, has a height H in a thickness direction of the display system and a width W along the first direction, H/W≥1.

18. The display system of claim 15, wherein the second devices are disposed on a same common substrate, and wherein at least in regions between the second devices and for a substantially normally incident light and for each of the first and second polarization states, the substrate has an optical transmittance of greater than about 60% at least at the at least the second wavelength.
